(19) United States
(12) Patent Application Publication
(10) Pub. No.: US 2005/0117544 A1
(43) Pub. Date: Jun. 2, 2005

(54) System and method for evaluating candidate networks for mobile communication device data throughput

(75) Inventors: Norman Goris, Dortmund (DE); Wolfgang Scheit, Rothenbach (DE)

Correspondence Address: HITT GAINES, PC;AGERE SYSTEMS INC., PO BOX 832570, RICHARDSON, TX, 75083, US

(73) Assignee: Agere Systems, Incorporated, Allentown, PA (US)

(21) Appl. No.: 10/725,643

(22) Filed: Dec. 2, 2003

(51) Int. Cl. H04Q 7/00

(52) U.S. Cl. 370/332

(57) ABSTRACT

A system for, and method of, selecting one of at least two different candidate wireless communication networks for data communication by a mobile communication device and a wireless communication device incorporating the system or the method. In one embodiment, the system includes a network selector that employs the mobile communication device to perform data transfers between the mobile communication device and communication server associated with the at least two different candidate wireless communication networks and performs an evaluation of the at least two different candidate wireless communication networks based on at least one data communication quality parameter.

### TECHNICAL FIELD OF THE INVENTION

The present invention is directed, in general, to wireless telecommunications and, more specifically, to a system and method for evaluating candidate networks for mobile communication device data throughput.

### BACKGROUND OF THE INVENTION

Mobile communication devices are increasingly used for more than just speech communication. A variety of services, including messaging services (such as the Short Message Service, or SMS; the Electronic Message Service, or EMS; and the Multimedia Messaging Service, or MMS), data communication services that use, e.g., the Wireless Application Protocol (WAP), e-mail or fax services are available to a user of a mobile communication device.

Such services have grown more sophisticated in an effort to keep the user attracted to them. Simple text services have matured into more data-intensive graphics and video services. Accordingly, a constantly rising demand for data throughput has arisen.

Thus, associated wireless communication networks have also gone through a concomitant development process. For the Global Communication System (GSM), methods were introduced that allow higher data throughput, examples are High Speed Circuit Switched Data (HSCSD), General Packet Radio Services (GPRS) or Enhanced Data Rates for GSM Evolution (EDGE). The coming widespread introduction of the third generation network Universal Mobile Telecommunications System (UMTS) will bring another major step with regard to data throughput.

The higher possible data rates of the above mentioned networks are however diminished significantly as larger numbers of users make concurrent use of them. Especially when using packet switched data transmission, the available data rate is shared among users located in the same cell of a cellular communication network. Data throughput also depends, of course, on the quality of the radio connection and the internal structure of the communication network.

It is known that for the purpose of optimizing their communication networks, service providers have means for coverage testing and for testing different aspects of the network quality, for example availability, session drop rate, data throughput and the like. To achieve this, it is common to use specially designed and expensive mobile communication devices, so called “trace mobiles.”

A user with a commercial mobile communication device may be in a situation in which he can choose between several networks to use for data communication, for example when his contract allows the use of different networks or when he is roaming in a foreign country. Unfortunately, in such a situation, the user lacks a way of automatically testing the available networks objectively and in an easy and fast way and to so decide for the network with the best performance at his current location and at the current time.

Lacking an automatic way, he has to either decide for a network by mere chance or he has to start a data session with each network and decide thereafter subjectively which network had the better performance, losing time in either case. Accordingly, what is needed in the art is a way of evaluating candidate networks for mobile communication device data throughput.

### SUMMARY OF THE INVENTION

To address the above-discussed deficiencies of the prior art, the present invention provides a system for selecting one of at least two different candidate wireless communication networks for data communication by a mobile communication device and a wireless communication device incorporating the system or the method. In one embodiment, the system includes a network selector that employs the mobile communication device to perform data transfers between the mobile communication device and communication server associated with the at least two different candidate wireless communication networks and performs an evaluation of the at least two different candidate wireless communication networks based on at least one data communication quality parameter.

In another aspect, the present invention provides a method of selecting one of at least two different candidate wireless communication networks for data communication by a mobile communication device. The method includes: (1) performing data transfers between the mobile communication device and communication server associated with the at least two different candidate wireless communication networks and (2) evaluating the at least two different candidate wireless communication networks based on at least one data communication quality parameter.

In yet another aspect, the present invention provides a mobile communication device. The mobile communication device includes: (1) a keypad, (2) a display and (3) a network selector, associated with the keypad and the display, that employs the mobile communication device to perform data transfers between the mobile communication device and communication server associated with the at least two different candidate wireless communication networks and performs an evaluation of the at least two different candidate wireless communication networks based on at least one data communication quality parameter.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a system for evaluating candidate networks for mobile communication device data throughput constructed according to the principles of the present invention; and

FIG. 2 illustrates a method of evaluating candidate networks for mobile communication device data throughput constructed according to the principles of the present invention.

### DETAILED DESCRIPTION

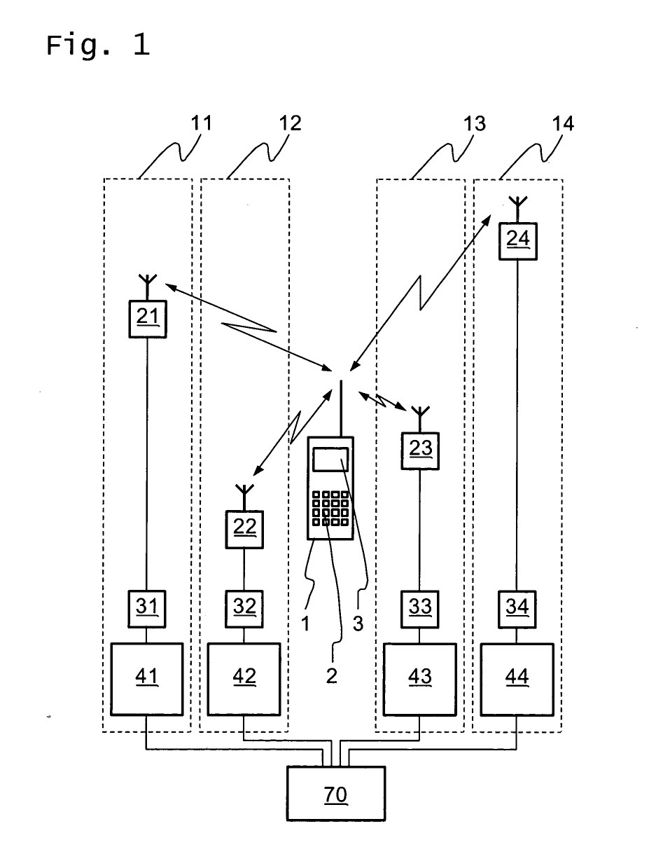

Referring initially to FIG. 1, illustrated is a system for evaluating candidate networks for mobile communication device data throughput constructed according to the principles of the present invention. FIG. 1 shows a GSM or UMTS mobile communication device 1 within the range of four mobile communication networks 11, 12, 13 and 14. The mobile communication device is provided with a keypad 2 and a display 3. The mobile communication networks support GPRS and comprise a base transceiving station 21, 22, 23 or 24, a base station controller 31, 32, 33 or 34 and a communication server 41, 42, 43 or 44. It is clear to those skilled in the art that the aforementioned components are merely an exemplary portion of a real mobile communication network. A real network typically comprises a large number of each of those components. Each network comprises also several further components not shown in FIG. 1. These can be for example serving GPRS support nodes, gateway GPRS support nodes or gateway mobile switching centers.

Each of the shown communication networks has access to the same data server 70. This can be, for instance, a WAP server or any other data server accessible via a mobile communication network.

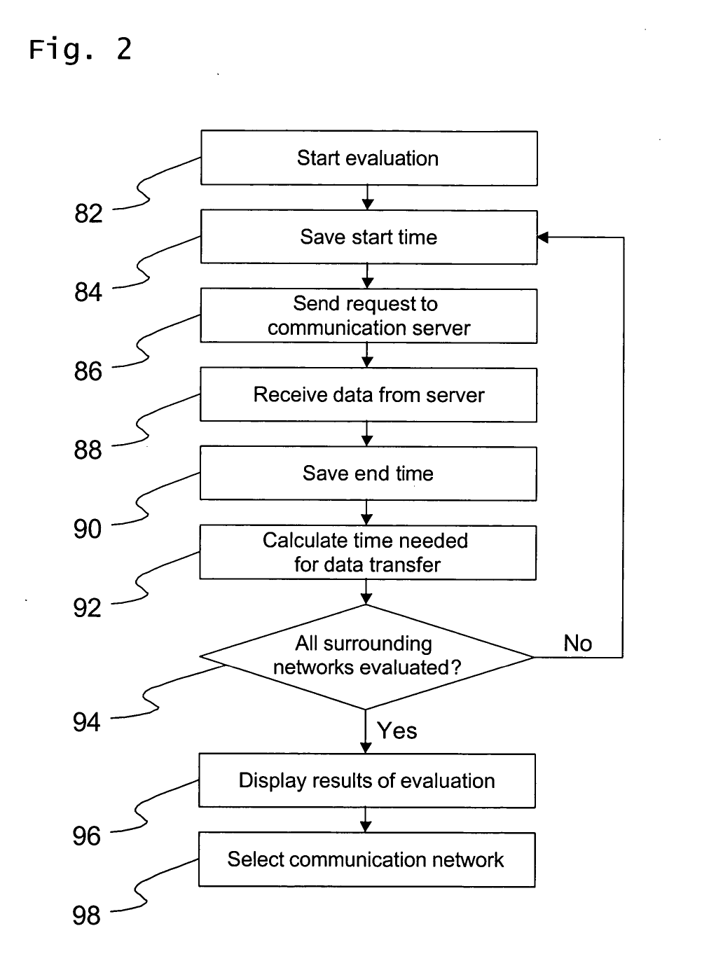

Turning now to FIG. 2, illustrated is a method of evaluating candidate networks for mobile communication device data throughput constructed according to the principles of the present invention.

The user starts a “communication wizard” application stored in the memory of his mobile communication device 1. (The “communication wizard” is a software embodiment of a network selector.) This communication wizard comprises a dialog displayed on the display 3 of the mobile communication device 1. Here the user has the option to start the evaluation 82 through an input via the keypad 2.

After the evaluation is started the start time is saved 84 in the mobile communication device 1. Then a request is sent 86 to the communication server 41 of the first communication network 11 for receiving data located on the data server 70.

The necessary information for the request, such as the IP address of the data server 70, is saved in the memory of the mobile communication device 1 beforehand.

After the complete data is received 88 from the communication server 41 or a definable time-out period has run out without receiving the complete data, an end time is saved 90 in the mobile communication device 1.

From the start time and the end time the time needed for the data transfer is calculated 92 and also saved in the mobile communication device 1.

The steps 84 to 92 are then performed for the remaining communication networks 12, 13 and 14. For this purpose the information whether a communication network already has been evaluated is also saved. This information is used to decide whether all networks have been evaluated 94.

When this is the case the results of the evaluation are displayed 96 on the display 3 of the mobile communication device 1 as the next dialog of the communication wizard. The results are displayed in the form of a list, a list entry comprising the network identifier and the time needed for the above described data transfer as a numerical value.

From this list, the user can select one of the networks 98 by input via the keypad 2. This information is saved and the chosen communication network is used for the following data sessions. The communication wizard is then terminated.

Although the invention is described with regard to a specific embodiment, the invention encompasses at least the following several modified embodiments.

For example, instead of being based on GPRS standards the data communication could also be based on HSCSD or EDGE standards or in principle any other also future standards for data communication in a mobile communication network.

Further, in addition to the data throughput availability of the network, session drop rate or other quality parameters could also be evaluated. Also the evaluation could be performed automatically at selectable time intervals and the evaluation results could be set in relation to charging information.

Although the present invention has been described in detail, those skilled in the art should understand that they can make various changes, substitutions and alterations herein without departing from the spirit and scope of the invention in its broadest form.

1. A system for selecting one of at least two different candidate wireless communication networks for data communication by a mobile communication device, comprising:
a network selector that:
employs said mobile communication device to perform data transfers between said mobile communication device and communication server associated with said at least two different candidate wireless communication networks, and
performs an evaluation of said at least two different candidate wireless communication networks based on at least one data communication quality parameter.

2. The system as recited in claim 1 wherein said network selection subsystem causes said wireless communication device to employ one of said at least two different candidate wireless communication networks based upon an outcome of said evaluation.

3. The system as recited in claim 1 wherein said at least two different candidate wireless communication networks comprise:
a Global System for Mobile Communication (GSM) network, and
a Universal Mobile Telecommunication System (UMTS) network.

4. The system as recited in claim 1 wherein said at least two different candidate wireless communication networks are packet switched data transmission networks conforming to a standard selected from the group consisting of:
General Packet Radio Service (GPRS),
High Speed Circuit Switched Data (HSCSD), and
Enhanced Data Rates for GSM Evolution (EDGE).

5. The system as recited in claim 1 wherein said mobile communication device is selected from the group consisting of:
a mobile telephone,
a personal digital assistant (PDA), and
a mobile digital assistant (MDA).

6. The system as recited in claim 1 wherein said at least one data communication quality parameter includes transfer time.

7. The system as recited in claim 1 wherein said at least one data communication quality parameter includes communication drops.

8. The system as recited in claim 1 wherein said network selector employs a display of said mobile communication device to notify a user of an outcome of said evaluation.

9. The system as recited in claim 1 wherein said network selector takes charge rates associated with said at least two different candidate wireless communication networks into account in performing said evaluation.

10. The system as recited in claim 1 wherein said network selector automatically performs said data transfers and evaluation.

11. A method of selecting one of at least two different candidate wireless communication networks for data communication by a mobile communication device, comprising:
performing data transfers between said mobile communication device and communication server associated with said at least two different candidate wireless communication networks; and
evaluating said at least two different candidate wireless communication networks based on at least one data communication quality parameter.

12. The method as recited in claim 11 further comprising causing said wireless communication device to employ one of said at least two different candidate wireless communication networks based upon an outcome of said evaluation.

13. The method as recited in claim 11 wherein said at least two different candidate wireless communication networks comprise:
a Global System for Mobile Communication (GSM) network, and
a Universal Mobile Telecommunication System (UMTS) network.

14. The method as recited in claim 11 wherein said at least two different candidate wireless communication networks are packet switched data transmission networks conforming to a standard selected from the group consisting of:
General Packet Radio Service (GPRS),
High Speed Circuit Switched Data (HSCSD), and
Enhanced Data Rates for GSM Evolution (EDGE).

15. The method as recited in claim 11 wherein said mobile communication device is selected from the group consisting of:
a mobile telephone,
a personal digital assistant (PDA), and
a mobile digital assistant (MDA).

16. The method as recited in claim 11 wherein said at least one data communication quality parameter includes transfer time.

17. The method as recited in claim 11 wherein said at least one data communication quality parameter includes communication drops.

18. The method as recited in claim 11 further comprising employing a display of said mobile communication device to notify a user of an outcome of said evaluation.

19. The method as recited in claim 11 further taking charge rates associated with said at least two different candidate wireless communication networks into account in performing said evaluation.

20. The method as recited in claim 11 further comprising automatically performing said data transfers and evaluation.

21. A mobile communication device, comprising:
a keypad;
a display; and
a network selector, associated with said keypad and said display, that employs said mobile communication device to perform data transfers between said mobile communication device and communication server associated with said at least two different candidate wireless communication networks and performs an evaluation of said at least two different candidate wireless communication networks based on at least one data communication quality parameter.

22. The mobile communication device as recited in claim 21 wherein said mobile communication device is selected from the group consisting of:
a mobile telephone,
a personal digital assistant (PDA), and
a mobile digital assistant (MDA).

23. The mobile communication device as recited in claim 21 wherein said network selector employs said display to notify a user of an outcome of said evaluation.
